(19) United States
(12) Patent Application Publication
(10) Pub. No.: US 2003/0020602 A1
(43) Pub. Date: Jan. 30, 2003

(54) Communication system and method for a mobile object

(75) Inventors: Naomichi Hata, Edogawa-ku (JP); Hiroshi Tawada, Bunkyo-ku (JP); Hiroyuki Yamada, Edogawa-ku (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, Toyota-shi (JP)

(21) Appl. No.: 10/180,301

(22) Filed: Jun. 27, 2002

(30) Foreign Application Priority Data
Jul. 27, 2001 (JP) 2001-227769

(51) Int. Cl. B60Q 1/00

(52) U.S. Cl. 340/425.5; 340/988; 340/990; 340/901; 340/995

(57) ABSTRACT

A communication system installed in a mobile object includes a communication module designed for data communication data, and a connecting portion to which an audio communication device is connected. When the communication module is installed in the mobile object, it is possible to talk with another without using the communication

The disclosure of Japanese Patent Application No. 2001-227769 filed on Jul. 27, 2001, including the specification, drawings and abstract is incorporated herein by reference in its entirety.

### BACKGROUND OF THE INVENTION

1. Field of Invention

The invention relates to a communication module designed for data communication installed in a mobile object e.g., (a vehicle or a portable-type terminal) and which makes it possible to talk (audio communication) with someone without using the communication module.

2. Description of Related Art

The present applicant has been engaged in developing communication systems with which one can receive a variety of services (e.g., a service of providing pay contents) from an information center, or the like, via a communication module installed in a mobile object (e.g., a vehicle or a portable terminal such as a PDA or a mobile-type personal computer). The communication module is a communication unit designed for data communication. That is, the communication module carries out data communication with a specific subscriber, such as, an information center via a cellular phone network.

However, since the communication module is a communication unit designed for data communication, it cannot be used for verbal communication. This is a problem to be solved by the invention. Although it is possible to design a communication module with which one can carry out data communication and talk with someone, a substantial rise in cost is inevitable. Further, a single phone number is used for data communication and verbal communication. Therefore, it is impossible to carry out data communication while talking with someone, and vice versa. Even if the communication module is designed to realize both data communication and verbal communication, there are some instances where a single person possesses a plurality of mobile objects or where a plurality of persons share a single mobile object. That is, it is foreseeable that the communication module may not receive a considerable number of messages intended for verbal communication.

### SUMMARY OF THE INVENTION

This invention has been made in view of the aforementioned circumstances. It is an object of the invention to make it possible to talk with someone without using a communication module designed for data communication in the case where the communication module is installed for data communication in a mobile object.

To achieve the object stated above, the invention provides a communication system that is installed in a mobile object and that includes a communication module designed for data communication and a connecting portion to which an audio communication device allowing audio communication is connected.

According to a further aspect of the invention, there is provided a method of communication for a communication system adapted to a mobile object. This method comprises the steps of communicating data by a communication module and audibly communicating by an audio communication device independently from the data communication.

The communication system constructed and the method of communication for the communication system make it possible to carry out data communication by the communication module designed for data communication, and to carry out audio communication by an audio communication device. The audio communication device is a cellular phone, a PHS phone, or the like.

### BRIEF DESCRIPTION OF THE DRAWINGS

The above-mentioned and other objects, features, advantages, technical and industrial significance of this invention will be better understood by reading the following detailed description of exemplary embodiments of the invention, when considered in connection with the accompanying drawings.

FIG. 1 is a schematic block diagram of an accounting data management system according to an embodiment of the invention;

FIG. 2 shows one example of how a communication module is installed according to the embodiment of the invention;

FIG. 3 shows a logical structure of a database held in an information center according to the embodiment of the invention;

FIG. 4 is a flowchart that explains how the accounting data management system operates according to the embodiment of the invention; and

FIG. 5 is a schematic block diagram of the accounting data management system according to the embodiment of the invention.

### DETAILED DESCRIPTION OF EXEMPLARY EMBODIMENTS

In the following description and the accompanying drawings, the invention will be described in more detail with reference to exemplary embodiments thereof.

A communication system for a mobile object according to an embodiment of the invention will be described hereinafter with reference to the drawings, on the basis of an example in which the invention is applied to an accounting data management system. This exemplary embodiment incorporates a vehicle as an example of the mobile object.

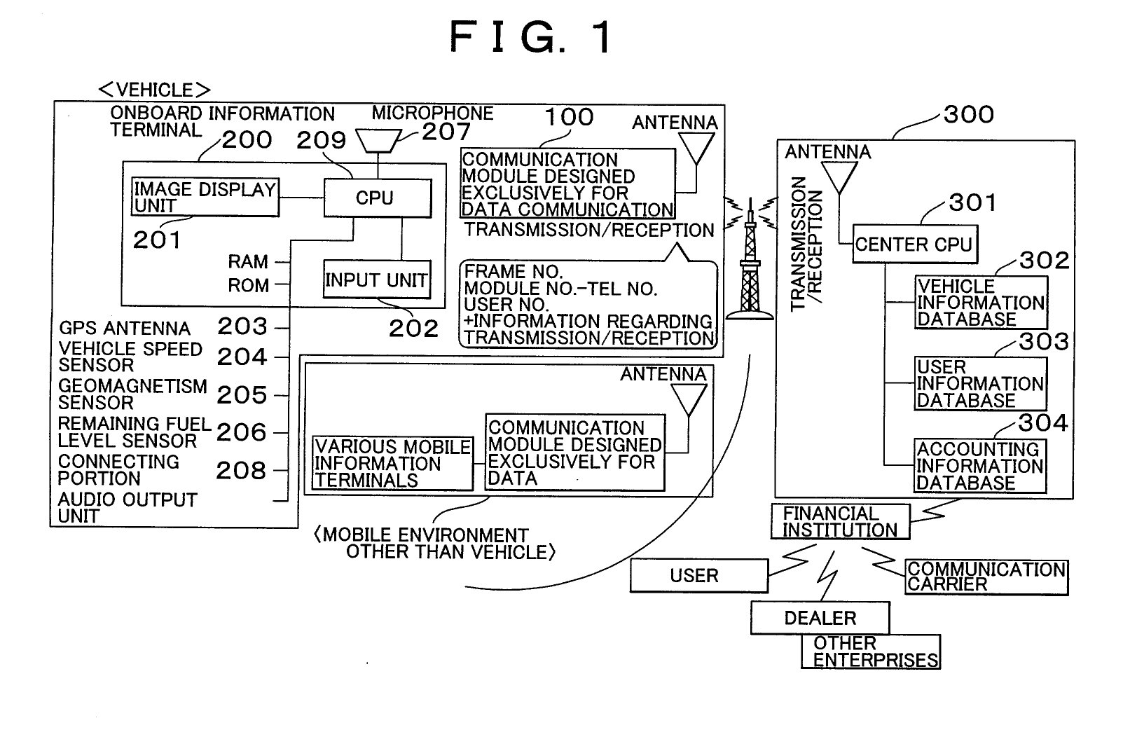

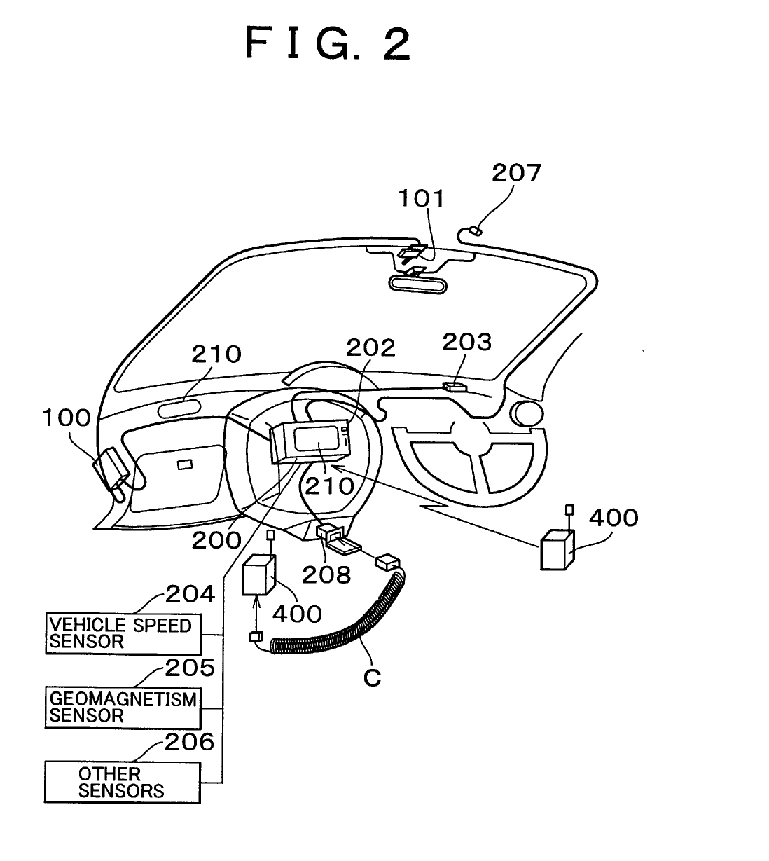

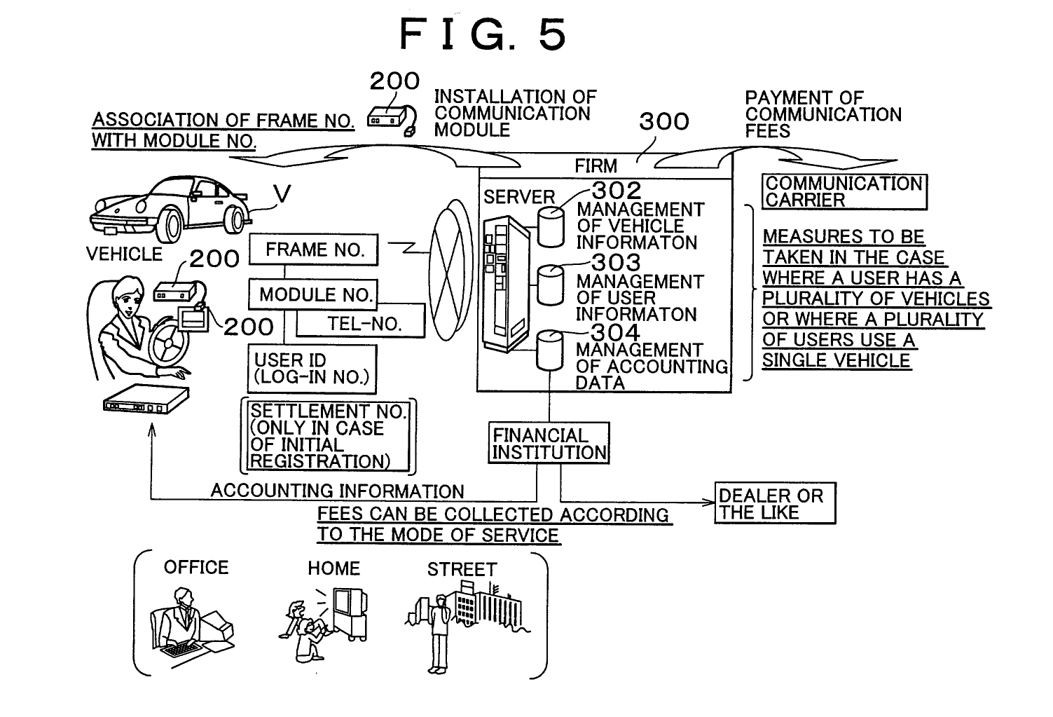

FIGS. 1 and 5 are schematic block diagrams of an accounting data management system. FIG. 2 shows how a communication module and the like are installed. As shown in FIGS. 1 and 5, the accounting data management system includes a communication module 100, an onboard information terminal 200, and an information center 300. The communication module 100 and the onboard information terminal 200 are installed in a vehicle V.

The communication module 100 is a communication device designed for data communication (designed exclusively for data communication in some cases) via a cellular phone network (or via a public phone network, internet, or the like) with a specific subscriber such as the information center 300. In a communication mode, the communication module 100 adopts a packet switching mode in which the amount of fee depends on the size of data. Therefore, no fee is charged unless data is transmitted or received.

As shown in FIG. 2, the communication module 100 is designed as a box assuming a generally rectangular external shape, and is installed in a dashboard. A storage device such as a ROM (not shown) is built into the communication module 100. A phone number of the communication module 100 and identity information regarding a vehicle (a univocal module number assigned to the communication module 100 and a frame number assigned to a body frame of the vehicle equipped with the communication module 100) are stored in the storage device. It is also appropriate that only the frame number assigned to the body frame of the vehicle equipped with the communication module 100 is used as vehicle identity information.

The phone number of the communication module 100 and the module number assigned to the communication module 100 are written into the storage device in a plant in which the communication module 100 is manufactured. The communication module 100 is installed in the vehicle in a plant in which the vehicle is manufactured.

Under the control of the onboard information terminal 200 or the like, the communication module 100 transmits a specific phone number to the outside as source information. A communication path for data communication with the information center 300 is thus established, whereby it becomes possible to exchange data with the information center 300. In an example where the communication module 100 is installed in the dashboard, an antenna 101 is disposed in the vehicle in a region where electric waves can be transmitted or received easily, for example, inside a wind shield connected to the communication module 100 for the purpose of ensuring stable data communication.

The communication module 100 is turned on when it is supplied with electric power for activation from a battery preinstalled in the vehicle (e.g., the battery designed to start an engine although not shown in the drawings) by turning an ignition key on (or according to other methods of starting the engine, e.g., using a wireless key). The communication module 100 is turned off, or stopped from being supplied with power for activation by turning the ignition key off (or according to other methods of stopping the engine, e.g., using a wireless key).

If the communication module 100 is always supplied with power from the battery for starting the engine, or an emergency communication power source installed in the vehicle in addition to the battery, such that it is possible for the communication module 100 to always receive data, the vehicle can be located by calling the communication module 100 from the information center 300. This ability to call the communication module 100 can be useful, for instance, in the case where someone has stolen the vehicle without starting the engine, for example, using a tow truck to haul the vehicle.

In this embodiment, a firm running the information center 300 bears communication costs for the communication module 100, such as, call data communication fees and monthly base rates under a contract with a communication carrier (e.g., a communication dealer). Accordingly, a user of the communication module 100 is not required to pay call data communication fees or monthly base rates but to pay only information fees (i.e., contents fees). The contract between the communication carrier and the firm running the information center 300 is made not as to each individual but as to each vehicle. The firm running the information center 300 pays communication costs to the communication carrier at predetermined timings.

The communication module 100 may either be separated from the onboard information terminal 200 as described above or be accommodated in the box of the onboard information terminal 200. It is not indispensable that the communication module 100 be installed inside the dashboard. It is also appropriate that the communication module 100 be disposed at other locations in the vehicle. For example, the communication module 100 may be disposed under a driver seat or a passenger seat, next to the driver seat or in a trunk.

The onboard information terminal 200 is connected to the communication module 100 via a predetermined interface. The onboard information terminal 200 is equipped with a CPU 209. The onboard information terminal 200 also includes a RAM, a ROM (or a storage medium such as a hard disk), an interface (not shown) for connection with the communication module 100, an image display unit 201, an input unit 202, etc. A memory card reader (not shown), an audio output unit 210, vehicle current position detection device (a GPS antenna 203, a vehicle speed sensor 204, a geomagnetism sensor 205, and the like), a remaining fuel level sensor 206, a connecting portion 208 to which a cellular phone 400 is connected, a hands-free unit (not shown), and the like are connected to the onboard information terminal 200. It is also appropriate that a GPS function is assigned to the communication module 100.

An operating system such as Windows CE, a navigation program, a music/image (still images or animated images) reproduction program, and the like are stored in the ROM. The navigation program and the music/image reproduction program are performed on the operating system.

The navigation program is mainly designed to provide guidance along a route from a certain position such as a current position of the vehicle to a destination on the basis of data read by the memory card reader from a memory card (map data, route search data, route guidance data, and the like). The current position of the vehicle is either an absolute position calculated on the basis of a signal received by a satellite via the GPS antenna 203 or a relative position calculated on the basis of signals detected by the vehicle speed sensor 204, the geomagnetism sensor 205, and the like.

The reproduction program is mainly designed to output music from the audio output unit 210, such as an onboard speaker, on the basis of a music file read by the memory card reader from the memory card and to display images on the image display unit 201, such as a liquid crystal display or a CRT display, on the basis of an image file read by the memory card reader from the memory card.

The data for route guidance and the music and image files are obtained from the information center 300 via the communication module 100 and recorded on the memory card. It is also appropriate that this data (the data for route guidance and the music and image files) is obtained in a compressed state from the information center 300, recorded on the memory card, and extracted for use in case of necessity. In some cases, this data is recorded on the memory card by a home computer (not shown) or the like.

A request for a predetermined service and the like are input to the input unit 202. The input unit may be a switch disposed on a front surface of the onboard information terminal 200, an audio recognition unit, a touch panel disposed on a display screen of the image display unit 201, or the like. The audio recognition unit extracts a characteristic pattern from a sound input through the onboard microphone 207, compares the characteristic pattern with an originally prepared pattern (stored in the ROM or the like), and thereby recognizes the input sound. If the audio recognition unit recognizes a specific pattern, information corresponding to the recognized pattern is input or a particular command is carried out.

The connecting portion 208 is a connection port to which the cellular phone 400 designed as telecommunication device that enables one to carry out audio communication with a specific subscriber is connected via a communication cable C, and employs a connector corresponding to the communication cable C. It is also appropriate that the cellular phone 400 be connected to the connecting portion 208 in a wireless manner. In this case, Bluetooth (a wireless communication technology designed for portable information transmitter-receivers and currently allowing data to be exchanged at a rate of 1 Mbps by electric waves in the band of 2.45 GHz) or the like is adopted as a method of communication.

The microphone 207, the audio output unit 210 (such as an onboard speaker), and the cellular phone 400 are connected to the hands-free unit, which makes it possible to talk with (or send a message to) a specific subscriber via the cellular phone 400. The hands-free unit may either be built into the onboard information terminal 200 or designed as a separate component.

If a request for a predetermined service is input to the onboard information terminal 200 via the input unit 202, the onboard information terminal 200 controls the communication module 100 such that a specific phone number is sent out as source information. A communication path for data communication with the information center 300 is thus established, whereby it becomes possible to exchange data with the information center 300. It is to be noted herein that the aforementioned processing is not performed if the communication path for data communication with the information center 300 has already been established when a request for a predetermined service is input to the input unit 202.

If the communication path for data communication with the information center 300 is established, the onboard information terminal 200 controls the communication module 100 such that a request input from the input unit 202 to determine a predetermined service, identity information regarding a user who makes the request, vehicle identity information (the frame number and the module number) stored in the storage device built into the communication module 100, and the phone number of the communication module 100 are transmitted to the information center 300 via the communication module 100.

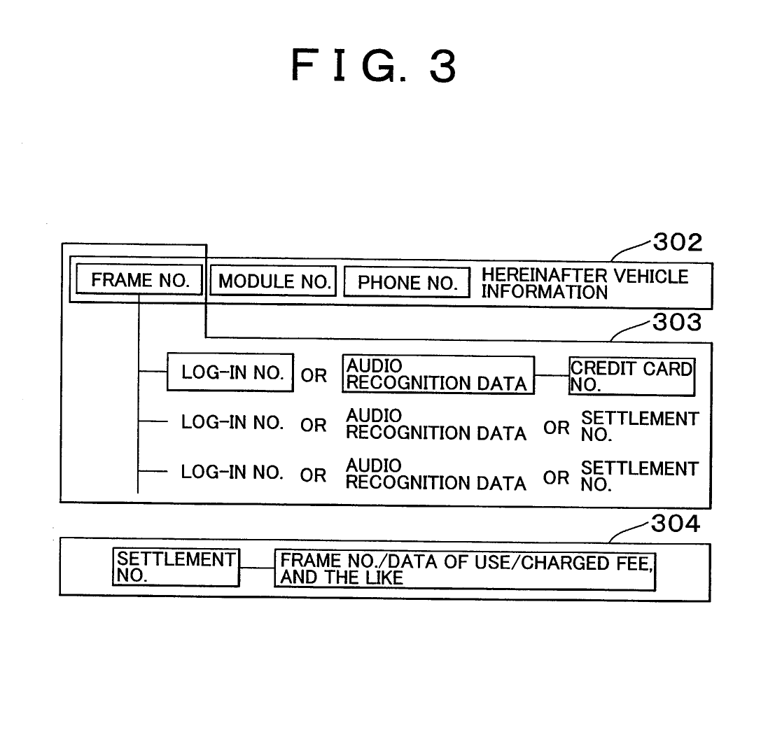

As shown in FIG. 1, the information center 300 is equipped with a CPU 301. The information center 300 also includes various databases (a vehicle information database 302, a user information database 303, an accounting information database 304, and the like) connected to the CPU 301 via buses and constructed in a storage device such as a hard disk. The information center also includes a communication module (not shown) designed for data communication with the vehicle-installed communication module 100, and the like. FIG. 3 shows a logical structure of these databases.

The vehicle information database 302 is comprised of items, such as, frame number, a module number, a phone number, and vehicle information. The user information database 303 comprises items, such as, a frame number, a user identity information (log-in number or audio recognition data), and a credit card number (settlement number). The user information database 303 corresponds to the database in which mobile object identity information and at least one piece of user identity information corresponding to the mobile object identity information are stored.

In some cases, a plurality of pieces of user identity information are registered for a frame number in the user information database 303. This is because if there are a plurality of users for a vehicle, for example, if a vehicle is used not only by its owner but also by his or her family members or acquaintances, fees must be charged to their accounts separately.

The accounting information database 304 comprises items, such as, credit card number (settlement number), frame number, date of use, and due amount (charged fee). Instead of using the accounting information database 304, it is also appropriate that items of credit card number, frame number, date of use, and due amount should be recorded in a file as accounting data every time it becomes necessary to charge a fee to someone. It is to be noted herein that the accounting data is useful as long as it includes certain items, such as a credit card number and a due amount.

The information center 300 is equipped with various content databases (not shown) in which data for route guidance, music files, image files, and the like are registered.

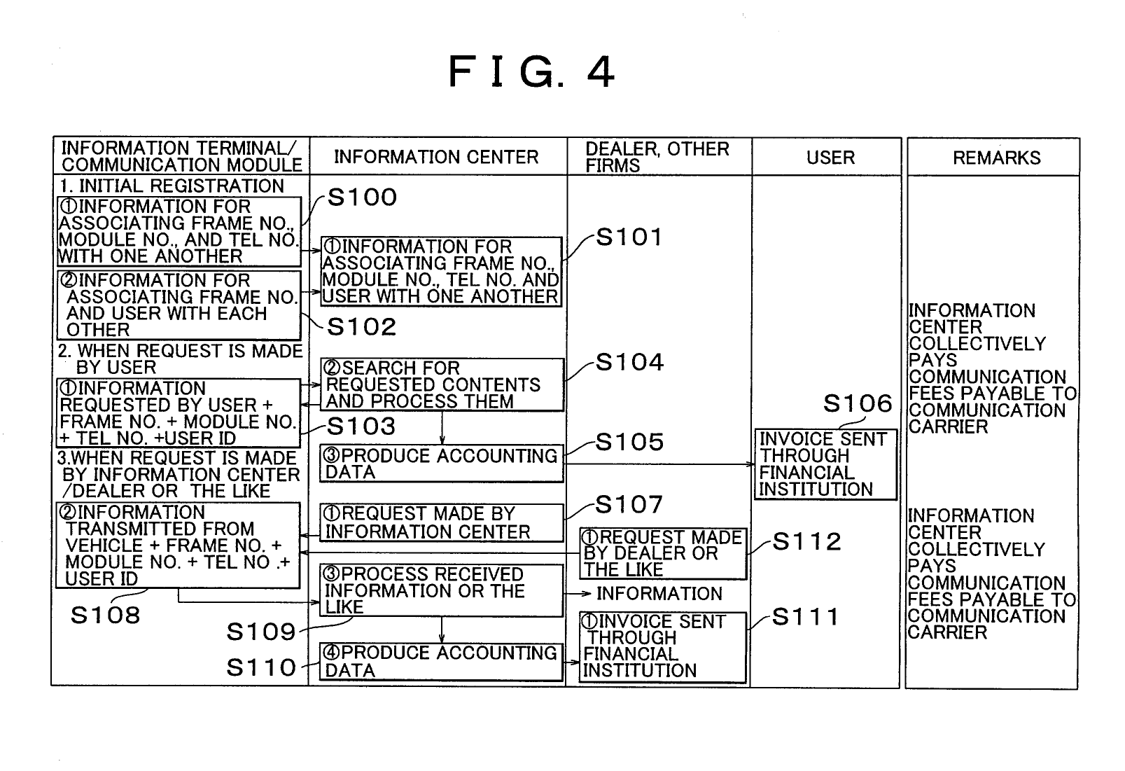

It will now be described with reference to FIG. 4 how the accounting data management system constructed as described above operates. FIG. 4 is a flowchart that illustrates how the accounting data management system operates.

The communication module 100 is installed in the vehicle in a plant in which the vehicle is manufactured. A frame number is written into a storage device or the like, which is built into the communication module 100 in one of the steps of manufacturing the vehicle. In the plant in which the vehicle is manufactured, vehicle identity information (the frame number and the module number) stored in the storage device built into the communication module 100 and the phone number of the communication module 100 are transmitted to the information center 300 via the communication module 100 before the vehicle is shipped from the plant (or before the vehicle equipped with the communication module 100 is sold to a user), for the purpose of a performance test of the communication module 100 (S100). The information center 300 receives the vehicle identity information (the frame number and the module number) and the phone number from the communication module 100 via the communication unit, and registers them in the vehicle information database 302 (S101). The frame number and the module number are associated with each other.

A user who bought the vehicle equipped with the communication module 100 inputs a credit card number (a settlement number) for payment of information fees (contents fees), his or her name, user identity information (a code number which is also used as a log-in number), contact addresses (a home address, a phone number, an e-mail address, and the like), a date of birth, and the like via the input unit 202 in accordance with an audio guidance output from the audio output unit 210 or with reference to an initial registration screen that is displayed by the image display unit 201, when the onboard information terminal 200 is operated for the first time. Information fees can also be paid according to the number of calls by a selected method of payment, that is, a prepaid card, automatic withdrawal from a designated account, or cash. Instead of using the user identity information described above, it is also possible to input a specific sound via the microphone 207, extract a characteristic pattern from the input sound, and use it as user identity information. Thus, it becomes possible to log into the information center 300 by uttering a specific sound.

User information that has been input is transmitted to the information center 300 via the communication module 100, together with the phone number of the communication module 100 and vehicle identity information (the frame number and the module number) stored in the storage device built into the communication module 100 (S102). After receiving the frame number and the user information, the information center 300 registers them in the user information database 303 (S101). Initial registration is thus completed. As a result, the frame number, the module number, the phone number of the communication module 100, and the user information are associated with one another.

An operation to be performed in obtaining various contents from the information center 300 via the communication module 100 will now be described.

If the ignition key is turned on, the power source for the communication module 100 is turned on, and the onboard information terminal 200 is activated. If the user has a cellular phone, the cellular phone is connected to the connecting portion 208, either with or without a wire. If the cellular phone then receives a call from someone outside, a hands-free talk operation is made possible, for example, by depressing a talk button (not shown) after a predetermined number of calling sounds. A hands-free talk operation is also made possible, for example, by designating a specific subscriber and depressing a dispatch button (not shown). Because a hands-free talk operation occurs with the intervention of the cellular phone, it can be realized in either case, whether or not call data is transmitted to the communication module 100.

In the case of receiving a pay service (e.g., obtaining pay contents) from the information center 300, identity information regarding a user who makes a request for the pay service is input via the input unit 202 (a password may also be input if required) so as to log into the information center 300. The pieces of information input in S102 as described above are used as the user identity information. In the case where a characteristic pattern of a specific sound is registered as the user identity information, the specific sound uttered during initial registration is uttered in front of the microphone 207 so as to log into the information center 300.

If someone other than the user who made an initial registration, such as a family member or an acquaintance of the owner of the vehicle receives a pay service (e.g., obtains pay contents) from the information center 300, information regarding the person to which the service is rendered is input (a password may also be input if required). The information regarding this user may include the same items as input during the initial registration. The user information that has been input is transmitted to the information center 300 via the communication module 100, together with the phone number of the communication module 100 and the vehicle identity information (the frame number and the module number) stored in the storage device built into the communication module 100. After receiving the frame number and the user information, the information center 300 registers them in the user information database 303. If the user different from the user who made the initial registration thereafter wants to obtain pay contents from the information center 300, he or she can log into the information center 300 simply by inputting his or her user identity information.

The information center 300 authenticates a user by an authentication server (not shown) or the like, and allows him or her to log in only if it is proved that he or she is qualified. Thus it becomes possible to make use of various contents and the like.

If a request for a predetermined service is made via the input unit 202 after log-in, the onboard information terminal 200 transmits the request for the predetermined service, identity information regarding a user who made the request (i.e., identity information regarding the user who has logged in to the information center 300), and vehicle identity information stored in the storage device built into the communication module 100 (the frame number and the module number) to the information center 300 via the communication module 100 (S103). When a request for the predetermined service is made, it is also appropriate that only the module number is transmitted as vehicle identity information.

Requests are made to obtain data for route guidance, map data regarding a region including a current position of the vehicle, music files, or image files. If a request for map data regarding a region including a current position of the vehicle is made, information regarding a position detected by the vehicle current position detection device is transmitted as well.

After receiving a request for a predetermined service, user identity information, and a frame number from the communication module 100, the information center 300 analyzes and retrieves the request. If the request has been made to obtain contents, the information center 300 reads contents corresponding to the request from the contents databases, processes them if necessary, and transmits the requested contents to the communication module 100 of a user who made the request (i.e., by a predetermined service performance device) (S104). The predetermined service performance device is processed by the CPU 301 and a predetermined program.

The onboard information terminal 200 receives contents via the communication module 100 and performs a program corresponding to the contents so as to provide guidance along a route, display a map of a region including a current position of the vehicle, or reproduce music or images.

Further, after receiving a request for a predetermined service, user identity information, and a frame number from the communication module 100, the information center 300 produces accounting data (i.e., by an accounting data production device). The accounting data production device is processed by the CPU 301 and a predetermined program. The accounting data produced is registered (or stored) in the accounting information database 304 in such a manner as to correspond to at least one piece of user identity information (a credit card number as user identity information) coincident with a piece of user identity information (identity information regarding a user who has logged in) received from the communication module 100. This piece of user identity information corresponds to a frame number received from the communication module 100.

Thus, if a plurality of users use a single vehicle to receive pay services from the information center, fees can be charged to their accounts separately.

The accounting data produced comprises at least a credit card number and a due amount (charged fee) corresponding to user identity information received from the communication module 100. In addition, the accounting data may also include a frame number received from the communication module 100, a date of use (i.e., a date when contents are obtained), and the like. The accounting data production device calculates the due amount as an amount corresponding to required contents of a predetermined service (the size of data or the type of contents required as a predetermined service). The accounting data that has been produced is transmitted to a computer installed in a financial institution at predetermined timings via a dedicated line or the like, so that the due amount is charged to a user (S106). The due amount may either be charged to a representative of the users such as an owner of each vehicle, or may be charged to each of the users individually. In the former case, an invoice may include information regarding the name of a user, the date of access, and the name of a vehicle used, as to each service available.

It will now be described how the communication system operates when the communication module 100 receives a message from the information center 300 (or a computer installed in a dealer).

The information center 300 performs a calling process to carry out data communication with the communication module 100, using a phone number registered in the vehicle information database 302. If the communication module 100 receives a message from the information center 300 when the power source for the communication module 100 has been turned on, the communication path for data communication with the information center 300 is established after a predetermined number of calling sounds, whereby it becomes possible to carry out data communication with the communication module 100. If the communication path is established, the information center 300 transmits a request to obtain vehicle information (S107). Alternatively, if the communication path is established, a dealer, or a firm, transmits the request to obtain vehicle information (S112).

The request to obtain vehicle information is made with the intention of obtaining a level of remaining fuel, a kilometrage, information regarding on-off state of a wiper, information regarding on-off state of a light at a specific location, information regarding air temperature and humidity at a specific location, a vehicle speed at a specific location, information regarding a route followed, vehicle type, the number of passengers, a destination, or the like. While the level of remaining fuel is detected by the remaining fuel level sensor, the kilometrage, the information regarding on-off state of the wiper, the information regarding on-off state of the light, the information regarding air temperature and humidity, the vehicle speed, and the information regarding the route followed are detected by other sensors. The request to obtain vehicle information may be made either to determine a specific piece of vehicle information or to determine all the pieces of vehicle information.

It is appropriate that vehicle information be detected and transmitted every time a request to obtain the vehicle information is made. Alternatively, vehicle information may also be stored in an onboard memory immediately after being detected each time and read out from the memory and transmitted if the information center 300 makes a request to obtain it.

After receiving a request to obtain vehicle information, the onboard information terminal 200 controls the communication module 100 such that a piece of vehicle information corresponding to the request, vehicle identity information, and user identity information are transmitted to the information center 300 via the communication module 100 (S108).

The information center 300 receives vehicle information and performs various processings on the basis of the vehicle information (S109). For example, if the level of remaining fuel received as vehicle information is equal to or lower than a preset threshold, data for providing guidance along a route to the nearest filling station can be transmitted to the vehicle. If the kilometrage received as vehicle information exceeds a preset threshold, data for recommending a vehicle inspection can be transmitted to the vehicle.

It is also possible to make a determination on meteorological situations in a specific district on the basis of pieces of vehicle information received, that is, information regarding on-off state of the wiper, information regarding on-off state of the light, and information regarding air temperature and humidity at a specific location. It is also possible to determine whether or not there is traffic jam on a specific road, on the basis of a piece of vehicle information received, such as, a vehicle speed at a specific location. It is also possible to make a database of formerly unregistered roads on the basis of a piece of vehicle information received, such as, information regarding a route followed (a series of positional data detected by the vehicle current position detection device).

It is also appropriate that the information center 300 may be designed to transmit advertising information or recall information if the communication path is established. In this case, the onboard information terminal 200 receives the advertising information or the recall information via the communication module 100, and displays it on the image display unit 201 or outputs a sound from the audio output unit 210.

If a computer installed in a dealer or the like makes a request to obtain vehicle information, the information center 300 produces accounting data for the dealer and registers the data in a predetermined database (S110). The accounting data is transmitted to a computer installed in a financial institution at predetermined timings via a dedicated line or the like, whereby fees are charged to the account of the dealer (S111).

The communication module 100 has been described above as the communication device designed for data communication. However, it is also appropriate that a button for emergency calls may be installed in a vehicle such that communication with a specific subscriber via the communication module 100 may be made possible if the button is depressed.

As described above, the communication module 100 is installed in the vehicle (built into the vehicle), whereby it becomes possible to create circumstances in which removal of the communication module 100, or cutoff of the power source is impossible in case of burglary.

Further, as described above, a certain firm can oversee contracts with communication enterprises collectively and make the contracts unknown to users, whereby it becomes possible to design an original business model concerning fees to be collected from subscribers. For example, if vehicle information is discovered, not by the request of a user, but at the request of a carmaker or a dealer, it is possible to control how to allocate invoices for communication fees.

Further, as described above, the frame number is used as information for specifying a vehicle. Therefore, when pieces of information regarding a running state or control of a vehicle (such as, running distance, running time, fuel consumption, operating conditions of instruments, malfunctions, and the like) and the like are introduced into the information center 300 by the request of a user, or at the request of a carmaker or a dealer, records ranging from manufacture to distribution can be added through specification of the vehicle (such as by a service of uplinking vehicle information). A carmaker or a dealer, or the like, can provide users of a specific vehicle with various pieces of information (such as by a service of downlinking pieces of information regarding the vehicle).

Further, as described above, identity information regarding a user who makes a request for a predetermined service is used as information for specifying a user. Therefore, it is possible to: assign the functions of an agent to an information center or a network server, amass information regarding personal tastes, and perform a service of providing information corresponding to a requirement made by each individual (a service of specifying an individual). When a plurality of users use a single vehicle, it is also possible to charge a fee to the account of each of the users.

Although the aforementioned embodiment handles the vehicle as an example of the mobile object, a portable terminal can also be regarded as the mobile object. In this case, a serial number assigned to the portable terminal is used as mobile object identity information.

The aforementioned accounting data management system is applicable for a variety of different services, such as a rent-a-car service. Fees for services rendered to a rental car are not charged to the account of a user of the rental car but to the account of a firm providing the rent-a-car service, because settlement of accounts of users causes many problems in terms of security. The accounting data management system can be applied to a rent-a-car service in the following manner. (1) While conducting an initial registration, a rent-a-car firm (corporation) registers a method of settlement, and at the same time, registers a certain vehicle as “a rental car”. (2) The rent-a-car firm inputs “log-in NO” via a network and creates an environment in which the service is available, without allowing users to perform operations associated with the service. (3) Service fees or communication fees are charged to the account of the rent-a-car firm. (4) Fee adjustments (determination of fees and timings for payment) between the rent-a-car firm and customers are made in compliance with a regulation enacted separately. (5) As a precaution against illegal access to the service, items such as duration of service, service fee, and the like are specified in a file of the rent-car-firm which is available on request. As a result, it is possible to trace a customer who has used the rent-a-car service.

The aforementioned accounting data system is also applicable to a transportation firm such as a taxi firm or a mail-delivery firm. In the case where fees for a service rendered to a taxi is not charged to the account of a driver of the taxi but to the account of a taxi firm, the same rules may apply as in the case of the rent-a-car service mentioned above.

If a plurality of persons in a single vehicle receive a service simultaneously, the details are as follows. In the case where there are a plurality of persons in a vehicle that receive a certain service during a journey, and where a fee is charged to the account of each of them, the following provisions may be followed. (1) The owner of the vehicle must register a method of settlement while conducting initial registration. (2) Someone other than the owner can conduct an initial registration or an on-the-spot registration. (3) Whenever someone gains access to the service, information regarding who has gained access to the service (such as who is to be charged a fee) is updated.

In the case where a mobile object is equipped with a communication module for data communication, the invention makes it possible to talk with someone without using the communication module.

In the illustrated embodiment shown in FIG. 1, the CPU 209 and the CPU 301 can be part of a controller(s) that is implemented as a programmed general purpose electronic control unit. It will be appreciated by those skilled in the art that the controller(s) can be implemented using a single special purpose integrated circuit (e.g., ASIC) having a main or central processor section for overall, system-level control, and separate sections dedicated to performing various different specific computations, functions and other processes under control of the central processor section. The controller can be a plurality of separate dedicated or programmable integrated or other electronic circuits or devices (e.g., hardwired electronic or logic circuits such as discrete element circuits, or programmable logic devices such as PLDs, PLAs, PALs or the like). The controller(s) can be implemented using a suitably programmed general purpose computer, e.g., a microprocessor, microcontroller or other processor device (CPU or MPU), either alone or in conjunction with one or more peripheral (e.g., integrated circuit) data and signal processing devices. In general, any device or assembly of devices on which a finite state machine capable of implementing the procedures described herein can be used as the controller(s). A distributed processing architecture can be used for maximum data/signal processing capability and speed.

While the invention has been described with reference to the exemplary embodiments thereof, it is to be understood that the invention is not limited to the exemplary embodiments or constructions. To the contrary, the invention is intended to cover various modifications and equivalent arrangements. In addition, while the various elements of the exemplary embodiments are shown in various combinations and configurations, which are exemplary, other combinations and configurations, including more, less or only a single element, are also within the spirit and scope of the invention.

What is claimed is:

1. A communication system installed in a mobile object, comprising:
a communication module designed for data communication; and
a connecting portion to which an audio communication device is connected that enables audio communication.

2. The communication system according to claim 1, wherein:
the audio communication device is connected to the connecting portion via a wire.

3. The communication system according to claim 1, wherein:
the audio communication device is connected to the connecting portion in a wireless manner.

4. The communication system according to claim 1, further comprising:
a hands-free unit designed to talk with a subscriber via the audio communication device.

5. The communication system according to claim 1, further comprising:
an input device that inputs a request for a predetermined service; and
a transmission device that transmits a request for the predetermined service to a specific subscriber via the communication module if the request for the predetermined service is input.

6. The communication system according to claim 5, wherein:
contents transmitted from the specific subscriber in accordance with the request for the predetermined service are received via the communication module.

7. The communication system according to claim 6, further comprising:
an image display unit; and
a display that displays an image on the image display unit on the basis of the contents received via the communication module.

8. The communication system according to claim 7, wherein:
the mobile object is a vehicle, and
a battery installed in the vehicle to start an engine supplies the communication module with an electric power.

9. The communication system according to claim 6, further comprising:
an audio output unit; and
an audio device that outputs music from the audio output unit on the basis of the contents received via the communication module.

10. The communication system according to claim 9, wherein:
the mobile object is a vehicle, and
a battery installed in the vehicle to start an engine supplies the communication module with an electric power.

11. The communication system according to claim 5, wherein:
the mobile object is a vehicle, and
a battery installed in the vehicle to start an engine supplies the communication module with an electric power.

12. The communication system according to claim 1, wherein:
the mobile object is a vehicle, and
a battery installed in the vehicle to start an engine supplies the communication module with an electric power.

13. The communication system according to claim 1, wherein:
the audio communication device is a cellular phone.

14. The communication system according to claim 1, wherein:
the mobile object is a portable terminal.

15. A method of communication for a communication system adapted to a mobile object, comprising the steps of:
communicating data by a communication module; and
audibly communicating by an audio output unit independently from the data communication.

16. The method according to claim 15, further comprising the steps of:
inputting a request for a predetermined service; and
transmitting the request for the predetermined service to a specific subscriber via the communication module if the request for the predetermined service is input.

17. The method according to claim 16, further comprising the step of:
receiving contents transmitted from the specific subscriber in accordance with the request for the predetermined service via the communication module.

18. The method according to claim 17, further comprising the step of:
displaying an image on an image display unit on the basis of contents received via the communication module.

19. The method according to claim 17, further comprising the step of:
outputting music from the audio output unit on the basis of contents received via the communication module.
